(19) United States
(12) Patent Application Publication
(10) Pub. No.: US 2025/0256822 A1
(43) Pub. Date: Aug. 14, 2025

(54) OUTBOARD MOTOR AND MARINE VESSEL

(71) Applicant: YAMAHA HATSUDOKI KABUSHIKI KAISHA, Iwata-shi (JP)

(72) Inventor: Yukihiro ISHIDA, Shizuoka (JP)

(21) Appl. No.: 19/021,393

(22) Filed: Jan. 15, 2025

(30) Foreign Application Priority Data
Feb. 13, 2024 (JP) 2024-019854

(51) Int. Cl. B63H 20/00; B63H 20/14; B63H 20/24; B63H 20/32; F01N 13/10; F02M 37/00

(52) U.S. Cl. CPC B63H 20/001; B63H 20/14; B63H 20/245; B63H 20/32; F01N 13/10; F02M 37/0017

(57) ABSTRACT

An outboard motor includes a first pipe made of metal to allow high-pressure hydrogen to be supplied therethrough to a first fuel injector, a second pipe made of metal to allow the high-pressure hydrogen to be supplied therethrough to a second fuel injector, and a flexible pipe made of bendable metal to connect the first pipe to the second pipe so as to allow the high-pressure hydrogen to flow therethrough to both the first pipe and the second pipe.

### CROSS REFERENCE TO RELATED APPLICATIONS

This application claims the benefit of priority to Japanese Patent Application No. 2024-019854 filed on Feb. 13, 2024. The entire contents of this application are hereby incorporated herein by reference.

### BACKGROUND OF THE INVENTION

### 1. Field of the Invention

The present invention relates to outboard motors and marine vessels.

### 2. Description of the Related Art

An outboard motor including a power unit is known in general. Such an outboard motor is disclosed in Japanese Patent Laid-Open No. 2020-101095, for example.

Japanese Patent Laid-Open No. 2020-101095 discloses an outboard motor including a power unit including a first cylinder head and a second cylinder head aligned in a right-left direction of an outboard motor main body, and a first fuel injector and a second fuel injector attached to the first cylinder head and the second cylinder head, respectively, to inject fuel inside the first cylinder head and the second cylinder head.

Although not described in Japanese Patent Laid-Open No. 2020-101095, an outboard motor as described in Japanese Patent Laid-Open No. 2020-101095 conceivably includes a power unit to be driven by hydrogen as fuel. In such a case, the outboard motor needs to include a first high-pressure metal pipe to supply high-pressure hydrogen to a first fuel injector, a second high-pressure metal pipe to supply high-pressure hydrogen to the second fuel injector, and a high-pressure metal connecting pipe to connect the first pipe to the second pipe such that high-pressure hydrogen flows through both the first pipe and the second pipe. In such a case, the first high-pressure pipe, the second high-pressure pipe, and the high-pressure connecting pipe are made of a highly rigid metal, and thus when connection positions of the connecting pipe to the first pipe and the second pipe are misaligned due to assembly errors of the first pipe and the second pipe to the outboard motor when the connecting pipe is connected to the first pipe and the second pipe, it is difficult to absorb the misalignments of the connection positions of the connecting pipe to the first pipe and the second pipe, unlike a rubber pipe used to supply gasoline to a power unit to be driven by the gasoline as fuel. That is, it becomes difficult to connect the metal connecting pipe to the first metal pipe and the second metal pipe. Therefore, a configuration is desired in which even when the connection positions between the high-pressure metal pipes to allow high-pressure hydrogen to be supplied therethrough to the first fuel injector and the second fuel injector are misaligned, the misalignments of the connection positions are absorbed, and the connections are easily made.

### SUMMARY OF THE INVENTION

Example embodiments of the present invention provide outboard motors and marine vessels that each absorb, even when connection positions between high-pressure metal pipes to allow high-pressure hydrogen to be supplied therethrough to fuel injectors of power units to be driven by hydrogen as fuel are misaligned, misalignments of the connection positions, and enable easy connections.

An outboard motor according to an example embodiment of the present invention includes an outboard motor main body, a power unit configured to be driven by hydrogen as a fuel and including a first cylinder head and a second cylinder head aligned along a right-left direction of the outboard motor main body, and a first fuel injector and a second fuel injector attached to the first cylinder head and the second cylinder head to inject the hydrogen into combustion chambers inside the first cylinder head and the second cylinder head, respectively, a propeller to be driven via a drive shaft and a propeller shaft both below the power unit, a first pipe made of metal to allow high-pressure hydrogen to be supplied therethrough to the first fuel injector, a second pipe made of metal to allow the high-pressure hydrogen to be supplied therethrough to the second fuel injector, and a flexible pipe made of bendable metal, having a corrugated or braided structure, to connect the first pipe to the second pipe so as to allow the high-pressure hydrogen to flow therethrough to both the first pipe and the second pipe.

An outboard motor according to an example embodiment of the present invention includes the first pipe made of metal to allow the high-pressure hydrogen to be supplied therethrough to the first fuel injector, the second pipe made of metal to allow the high-pressure hydrogen to be supplied therethrough to the second fuel injector, and the flexible pipe made of bendable metal, having a corrugated or braided structure, to connect the first pipe to the second pipe so as to allow the high-pressure hydrogen to flow therethrough to both the first pipe and the second pipe. Accordingly, even when connection positions of the flexible pipe to the first pipe and the second pipe are misaligned due to assembly errors of the first pipe and the second pipe to the outboard motor when the flexible pipe is connected to the first pipe and the second pipe, the misalignments of the connection positions of the flexible pipe to the first pipe and the second pipe are absorbed by the bendable flexible pipe. That is, the flexible pipe made of metal is easily connected to the first pipe and the second pipe, both of which are made of metal. Consequently, even when the connection positions between the high-pressure metal pipes to allow high-pressure hydrogen to be supplied therethrough to the fuel injectors of the power unit to be driven by hydrogen as fuel are misaligned, the misalignments of the connection positions are absorbed, and the connections are easily made. When a pressure from high-pressure hydrogen is not acting on the flexible pipe, the flexible pipe is bendable, and thus the flexible pipe is easily connected to the first pipe and the second pipe. When a pressure from the high-pressure hydrogen is acting on the flexible pipe, the rigidity of the flexible pipe is increased, and thus the strength against vibrations generated in the flexible pipe due to vibrations of the power unit, external disturbances (such as waves) acting on the outboard motor main body, etc. is increased.

An outboard motor according to an example embodiment of the present invention preferably further includes a first joint airtight against the high-pressure hydrogen to connect the first pipe to a first end of the flexible pipe, and a second joint airtight against the high-pressure hydrogen to connect the second pipe to a second end of the flexible pipe. Accordingly, the first joint and the second joint enable the high-pressure flexible pipe to be connected to the first high-pressure pipe and the second high-pressure pipe while airtightness against high-pressure hydrogen is achieved.

In an outboard motor according to an example embodiment of the present invention, the flexible pipe preferably extends along the right-left direction of the outboard motor main body. Accordingly, the first pipe and the second pipe, which are provided on one side and the other side in the right-left direction of the outboard motor main body, respectively, are connected to each other at the shortest distance.

In an outboard motor according to an example embodiment of the present invention, the power unit preferably includes a first exhaust manifold rearward of the first cylinder head in a forward-rearward direction of the outboard motor main body and connected to the first cylinder head to allow exhaust gas to pass therethrough from the first cylinder head, and a second exhaust manifold rearward of the second cylinder head in the forward-rearward direction of the outboard motor main body and connected to the second cylinder head to allow exhaust gas to pass therethrough from the second cylinder head, and at least a portion of the flexible pipe preferably overlaps the first exhaust manifold and the second exhaust manifold as viewed in an upward-downward direction of the outboard motor main body. Accordingly, in the forward-rearward direction perpendicular to the upward-downward direction of the outboard motor main body, the power unit and the flexible pipe are compactly configured.

In an outboard motor in which at least a portion of the flexible pipe overlaps the first exhaust manifold and the second exhaust manifold as viewed in the upward-downward direction of the outboard motor main body, the power unit preferably includes an exhaust pipe below the first exhaust manifold and the second exhaust manifold in the upward-downward direction of the outboard motor main body and connected to the first exhaust manifold and the second exhaust manifold to allow the exhaust gas that has passed through the first exhaust manifold and the exhaust gas that has passed through the second exhaust manifold to pass therethrough, and at least a portion of the flexible pipe preferably overlaps the exhaust pipe as viewed in the forward-rearward direction of the outboard motor main body. Accordingly, in the upward-downward direction perpendicular to the forward-rearward direction of the outboard motor main body, the power unit and the flexible pipe are compactly configured.

In an outboard motor in which at least a portion of the flexible pipe overlaps the exhaust pipe as viewed in the forward-rearward direction of the outboard motor main body, at least a portion of the flexible pipe is preferably forward of at least a portion of the exhaust pipe in the forward-rearward direction of the outboard motor main body. Accordingly, at least a portion of the flexible pipe easily overlaps the exhaust pipe as viewed in the forward-rearward direction of the outboard motor main body.

In an outboard motor in which at least a portion of the flexible pipe is forward of at least a portion of the exhaust pipe in the forward-rearward direction of the outboard motor main body, the power unit preferably includes a first cylinder head cover and a second cylinder head cover attached to rear sides of the first cylinder head and the second cylinder head, respectively, in the forward-rearward direction of the outboard motor main body, and at least a portion of the flexible pipe is preferably between the exhaust pipe and both the first cylinder head cover and the second cylinder head cover in the forward-rearward direction of the outboard motor main body. Accordingly, a space between the exhaust pipe and both the first cylinder head cover and the second cylinder head cover in the forward-rearward direction of the outboard motor main body is effectively used to locate the flexible pipe.

An outboard motor including the first joint and the second joint preferably further includes a third pipe made of metal and connected to the first pipe and the flexible pipe via the first joint to allow the high-pressure hydrogen to be supplied therethrough to the first pipe and the flexible pipe. Accordingly, the third pipe allows high-pressure hydrogen to be easily supplied to the first pipe and the flexible pipe.

In an outboard motor according to an example embodiment of the present invention, the outboard motor main body preferably includes a cowling to house the power unit, and the outboard motor preferably further includes a hydrogen detection sensor inside the cowling to detect the hydrogen. Accordingly, when hydrogen leaks from the pipes, the hydrogen detection sensor detects the hydrogen, and thus leakage of the hydrogen from the pipes is dealt with promptly.

In an outboard motor including the hydrogen detection sensor inside the cowling, the hydrogen detection sensor is preferably at least either at an upper end of the cowling or in a vicinity of a ventilation opening on a surface of the cowling that connects an inside of the cowling to an outside of the cowling. Accordingly, the hydrogen detection sensor is at a location inside the cowling at which hydrogen is relatively easy to detect, and thus when hydrogen leaks from the pipes, the hydrogen detection sensor easily detects the hydrogen. In this description, the term “vicinity of a ventilation opening” indicates a broader concept including the position of the ventilation opening itself, a position contacting the ventilation opening, and a position spaced apart from the ventilation opening but relatively close to the ventilation opening.

A marine vessel according to an example embodiment of the present invention includes a hull including a hydrogen tank filled with hydrogen, and an outboard motor attached to the hull. The outboard motor includes an outboard motor main body, a power unit configured to be driven by hydrogen as fuel and including a first cylinder head and a second cylinder head aligned along a right-left direction of the outboard motor main body, and a first fuel injector and a second fuel injector attached to the first cylinder head and the second cylinder head to inject the hydrogen into combustion chambers inside the first cylinder head and the second cylinder head, respectively, a propeller to be driven via a drive shaft and a propeller shaft both below the power unit, a first pipe made of metal to allow high-pressure hydrogen to be supplied therethrough to the first fuel injector, a second pipe made of metal to allow the high-pressure hydrogen to be supplied therethrough to the second fuel injector, and a flexible pipe made of bendable metal, having a corrugated or braided structure, to connect the first pipe to the second pipe so as to allow the high-pressure hydrogen to flow therethrough to both the first pipe and the second pipe.

A marine vessel according to an example embodiment of the present invention includes the first pipe made of metal to allow the high-pressure hydrogen to be supplied therethrough to the first fuel injector, the second pipe made of metal to allow the high-pressure hydrogen to be supplied therethrough to the second fuel injector, and the flexible pipe made of bendable metal, having a corrugated or braided structure, to connect the first pipe to the second pipe so as to allow the high-pressure hydrogen to flow therethrough to both the first pipe and the second pipe. Accordingly, similarly to the outboard motors according to example embodiments of the present invention described above, even when connection positions of the flexible pipe to the first pipe and the second pipe are misaligned due to assembly errors of the first pipe and the second pipe to the outboard motor when the flexible pipe is connected to the first pipe and the second pipe, the misalignments of the connection positions of the flexible pipe to the first pipe and the second pipe are absorbed by the bendable flexible pipe. Consequently, similarly to the outboard motors according to example embodiments of the present invention described above, even when the connection positions between the high-pressure metal pipes to allow high-pressure hydrogen to be supplied therethrough to the fuel injectors of the power unit are misaligned, the misalignments of the connection positions are absorbed, and the connections are easily made. Furthermore, similarly to the outboard motors according to example embodiments of the present invention described above, when a pressure from high-pressure hydrogen is not acting on the flexible pipe, the flexible pipe is bendable, and thus the flexible pipe is easily connected to the first pipe and the second pipe. When a pressure from high-pressure hydrogen is acting on the flexible pipe, the rigidity of the flexible pipe is increased, and thus the strength against vibrations generated in the flexible pipe due to vibrations of the power unit, external disturbances (such as waves) acting on the outboard motor main body, etc. is increased.

A marine vessel according to an example embodiment of the present invention preferably further includes a first joint airtight against the high-pressure hydrogen to connect the first pipe to a first end of the flexible pipe, and a second joint airtight against the high-pressure hydrogen to connect the second pipe to a second end of the flexible pipe. Accordingly, similarly to the outboard motors according to example embodiments of the present invention described above, the first joint and the second joint enable the high-pressure flexible pipe to be connected to the first high-pressure pipe and the second high-pressure pipe while airtightness against high-pressure hydrogen is achieved.

In a marine vessel according to an example embodiment of the present invention, the flexible pipe preferably extends along the right-left direction of the outboard motor main body. Accordingly, similarly to the outboard motors according to example embodiments of the present invention described above, the first pipe and the second pipe, which are provided on one side and the other side in the right-left direction of the outboard motor main body, respectively, are connected to each other at the shortest distance.

In a marine vessel according to an example embodiment of the present invention, the power unit preferably includes a first exhaust manifold rearward of the first cylinder head in a forward-rearward direction of the outboard motor main body and connected to the first cylinder head to allow exhaust gas to pass therethrough from the first cylinder head, and a second exhaust manifold rearward of the second cylinder head in the forward-rearward direction of the outboard motor main body and connected to the second cylinder head to allow exhaust gas to pass therethrough from the second cylinder head, and at least a portion of the flexible pipe preferably overlaps the first exhaust manifold and the second exhaust manifold as viewed in an upward-downward direction of the outboard motor main body. Accordingly, similarly to the outboard motors according to example embodiments of the present invention described above, in the forward-rearward direction perpendicular to the upward-downward direction of the outboard motor main body, the power unit and the flexible pipe are compactly configured.

In a marine vessel in which the flexible pipe overlaps the first exhaust manifold and the second exhaust manifold as viewed in the upward-downward direction of the outboard motor main body, the power unit preferably includes an exhaust pipe below the first exhaust manifold and the second exhaust manifold in the upward-downward direction of the outboard motor main body and connected to the first exhaust manifold and the second exhaust manifold to allow the exhaust gas that has passed through the first exhaust manifold and the exhaust gas that has passed through the second exhaust manifold to pass therethrough, and at least a portion of the flexible pipe preferably overlaps the exhaust pipe as viewed in the forward-rearward direction of the outboard motor main body. Accordingly, similarly to the outboard motors according to example embodiments of the present invention described above, in the upward-downward direction perpendicular to the forward-rearward direction of the outboard motor main body, the power unit and the flexible pipe are compactly configured.

In a marine vessel in which the flexible pipe overlaps the exhaust pipe as viewed in the forward-rearward direction of the outboard engine main body, at least a portion of the flexible pipe is preferably forward of at least a portion of the exhaust pipe in the forward-rearward direction of the outboard motor main body. Accordingly, similarly to the outboard motors according to example embodiments of the present invention described above, at least a portion of the flexible pipe easily overlaps the exhaust pipe as viewed in the forward-rearward direction of the outboard motor main body.

In a marine vessel in which at least a portion of the flexible pipe is forward of at least a portion of the exhaust pipe in the forward-rearward direction of the outboard motor main body, the power unit preferably includes a first cylinder head cover and a second cylinder head cover attached to rear sides of the first cylinder head and the second cylinder head, respectively, in the forward-rearward direction of the outboard motor main body, and at least a portion of the flexible pipe is preferably between the exhaust pipe and both the first cylinder head cover and the second cylinder head cover in the forward-rearward direction of the outboard motor main body.

Accordingly, similarly to the outboard motors according to example embodiments of the present invention described above, a space between the exhaust pipe and both the first cylinder head cover and the second cylinder head cover in the forward-rearward direction of the outboard motor main body is effectively used to locate the flexible pipe.

A marine vessel in which the outboard motor includes the first joint and the second joint preferably further includes a third pipe made of metal and connected to the first pipe and the flexible pipe via the first joint to allow the high-pressure hydrogen supplied from the hydrogen tank of the hull to be supplied therethrough to the first pipe and the flexible pipe. Accordingly, similarly to the outboard motors according to example embodiments of the present invention described above, the third pipe allows high-pressure hydrogen to be easily supplied to the first pipe and the flexible pipe.

In a marine vessel according to an example embodiment of the present invention, the outboard motor main body preferably includes a cowling to house the power unit, and the marine vessel preferably further includes a hydrogen detection sensor inside the cowling to detect the hydrogen. Accordingly, similarly to the outboard motors according to example embodiments of the present invention described above, when hydrogen leaks from the pipes, the hydrogen detection sensor detects the hydrogen, and thus leakage of the hydrogen from the pipes is dealt with promptly.

An outboard motor according to an example embodiment of the present invention includes a power unit including at least one cylinder bank including a plurality of cylinder rows, and a fuel injector to inject hydrogen into combustion chambers inside the plurality of cylinder rows of the cylinder bank, a propeller to be driven via a drive shaft and a propeller shaft both below the power unit, a fuel pipe made of metal to allow high-pressure hydrogen to be supplied therethrough to the fuel injector, a flexible pipe made of bendable metal, having a corrugated or braided structure, connected to the fuel pipe so as to allow the high-pressure hydrogen to flow therethrough to the fuel pipe, and a joint to connect the fuel pipe to the flexible pipe such that a central axis extending in a longitudinal direction of the fuel pipe and a central axis extending in a longitudinal direction of the flexible pipe intersect with each other. The flexible pipe is a rigid structural body when the high-pressure hydrogen is supplied therethrough.

An outboard motor according to an example embodiment of the present invention includes the flexible pipe made of bendable metal, having a corrugated or braided structure, and connected to the fuel pipe made of metal to allow the high-pressure hydrogen to be supplied therethrough to the fuel injector so as to allow the high-pressure hydrogen to flow therethrough to the fuel pipe. Accordingly, when the flexible pipe is connected to the fuel pipe, the bendable flexible pipe absorbs a misalignment of the connection position of the flexible pipe to the fuel pipe even when the connection position of the flexible pipe to the fuel pipe is misaligned due to an assembly error of the fuel pipe to the outboard motor. That is, the flexible pipe made of metal is easily connected to the fuel pipe made of metal. Consequently, similarly to the outboard motors and the marine vessels according to example embodiments of the present invention described above, even when the connection position between the high-pressure metal pipes to allow the high-pressure hydrogen to be supplied therethrough to the fuel injector of the power unit is misaligned, the misalignment of the connection position is absorbed, and the connection is easily made. Furthermore, when a pressure from the high-pressure hydrogen is not acting on the flexible pipe, the flexible pipe is bendable, and thus the flexible pipe is easily connected to the fuel pipe. In addition, the fuel injector includes the joint to connect the fuel pipe to the flexible pipe such that the central axis extending in the longitudinal direction of the fuel pipe and the central axis extending in the longitudinal direction of the flexible pipe intersect with each other, and the flexible pipe acts as a rigid structural body when high-pressure hydrogen is supplied therethrough. Thus, the strength against vibrations generated in the flexible pipe due to vibrations of the power unit, external disturbances (such as waves) acting on an outboard motor main body, etc., is increased.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view of a marine vessel according to an example embodiment of the present invention.

FIG. 2 is a side view of a marine vessel according to an example embodiment of the present invention.

FIG. 3 is a perspective view of a power unit according to an example embodiment of the present invention.

FIG. 4 is a diagram of a power unit according to an example embodiment of the present invention as viewed from the rear side in a forward-rearward direction of an outboard motor main body.

FIG. 5 is a diagram showing bending of a flexible pipe according to an example embodiment of the present invention.

FIG. 6 is a partial enlarged view of an exhaust manifold and a flexible pipe of a power unit according to an example embodiment of the present invention as viewed from above in an upward-downward direction of an outboard motor main body.

FIG. 7 is a diagram showing a state in which an exhaust pipe is removed from FIG. 4.

### DETAILED DESCRIPTION OF THE EXAMPLE EMBODIMENTS

Example embodiments of the present invention are hereinafter described with reference to the drawings.

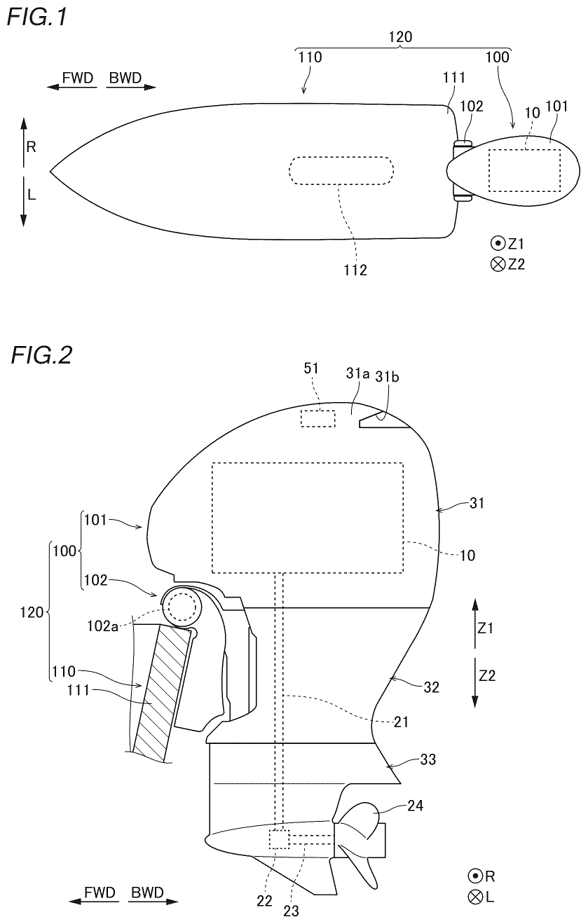

An outboard motor 100 and a marine vessel 120 according to example embodiments of the present invention are now described with reference to FIGS. 1 to 7. The marine vessel 120 may be a relatively small marine vessel used for sightseeing or fishing, for example.

As shown in FIG. 1, the marine vessel 120 includes a hull 110 and the outboard motor 100. The hull 110 includes a plurality of hydrogen tanks 112 filled with hydrogen. The plurality of hydrogen tanks 112 are housed inside the hull 110. The outboard motor 100 is attached to the hull 110. The outboard motor 100 includes a power unit 10 to be driven by hydrogen as fuel.

As shown in FIG. 2, the outboard motor 100 includes an outboard motor main body 101 and a bracket 102. The outboard motor main body 101 is attached to a stern 111 of the hull 110 via the bracket 102. The outboard motor main body 101 is tiltable relative to the hull 110 about a tilt shaft 102a provided on the bracket 102 and extending along a right-left direction of the outboard motor main body 101. In the figures, FWD, BWD, L, R, Z1, and Z2 indicate the front side in a forward-rearward direction of the outboard motor main body 101, the rear side in the forward-rearward direction of the outboard motor main body 101, the left side (port side) in the right-left direction of the outboard motor main body 101, the right side (starboard side) in the right-left direction of the outboard motor main body 101, the upper side in an upward-downward direction of the outboard motor main body 101, and the lower side in the upward-downward direction of the outboard motor main body 101, respectively, when the outboard motor main body 101 is not tilted relative to the hull 110.

The outboard motor main body 101 includes the power unit 10, a drive shaft 21, a gearing 22, a propeller shaft 23, and a propeller 24. The power unit 10 includes an internal combustion engine to generate a driving force. The drive shaft 21 extends along the upward-downward direction of the outboard motor main body 101. An upper end of the drive shaft 21 is connected to a crankshaft (not shown) of the power unit 10. That is, the drive shaft 21 is provided below the power unit 10. A lower end of the drive shaft 21 is connected to the gearing 22. The propeller shaft 23 extends along the forward-rearward direction of the outboard motor main body 101. That is, the propeller shaft 23 is provided below the power unit 10. A front end of the propeller shaft 23 is connected to the gearing 22. A rear end of the propeller shaft 23 is connected to the propeller 24. A driving force is transmitted from the power unit 10 to the propeller 24 via the drive shaft 21, the gearing 22, and the propeller shaft 23. The propeller 24 generates a propulsive force to propel the marine vessel 120 by rotating in the water by the driving force transmitted from the power unit 10. The power unit 10 is described in detail below.

The outboard motor main body 101 includes a cowling 31, an upper case 32, and a lower case 33. The cowling 31, the upper case 32, and the lower case 33 define a housing of the outboard motor main body 101. The cowling 31 is made of resin, for example. The upper case 32 and the lower case 33 are preferably made of metal (aluminum, for example). The cowling 31 houses the power unit 10. The upper case 32 is located below the cowling 31. The upper case 32 houses an upper portion of the drive shaft 21. The lower case 33 is located below the upper case 32. The lower case 33 houses a lower portion of the drive shaft 21, the gearing 22, and the propeller shaft 23. The propeller 24 is located behind the lower case 33.

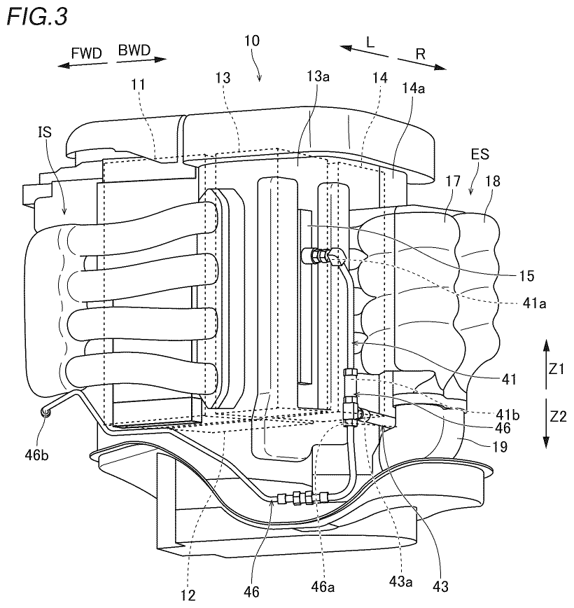

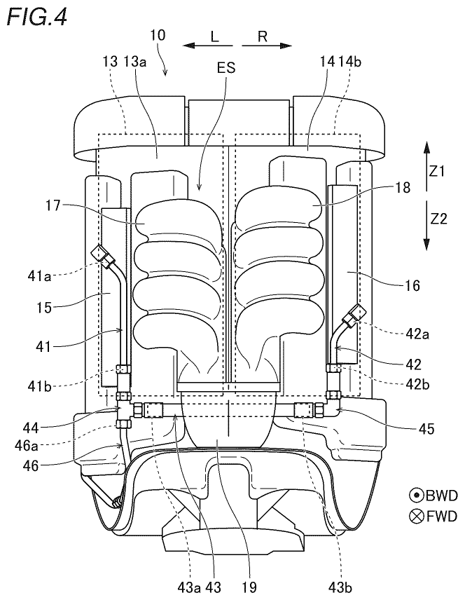

As shown in FIG. 3, the power unit 10 includes a cylinder block including a first cylinder block 11 and a second cylinder block 12, a first cylinder head 13, a second cylinder head 14, a first fuel injector 15, and a second fuel injector 16 (see FIG. 4).

Each of the first cylinder block 11 and the second cylinder block 12 includes a plurality of cylinders (not shown) aligned in the upward-downward direction of the outboard motor main body 101 (see FIG. 2). The first cylinder block 11 and the second cylinder block 12 are aligned in the right-left direction of the outboard motor main body 101. Each of the first cylinder block 11 and the second cylinder block 12 includes a plurality of (four, for example) cylinders. The plurality of cylinders of the first cylinder block 11 and the plurality of cylinders of the second cylinder block 12 are alternately provided in the upward-downward direction of the outboard motor main body 101. The plurality of cylinders of the first cylinder block 11 and the plurality of cylinders of the second cylinder block 12 are provided in a V-shape, as viewed in the upward-downward direction of the outboard motor main body 101. That is, the power unit 10 is a V-type or V-shaped engine.

The first cylinder head 13 and the second cylinder head 14 are connected to the rear sides of the first cylinder block 11 and the second cylinder block 12, respectively, in the forward-rearward direction of the outboard motor main body 101 (see FIG. 2). The first cylinder head 13 and the second cylinder head 14 are aligned along the right-left direction of the outboard motor main body 101. The first cylinder block 11 and the first cylinder head 13 define a cylinder bank in which a plurality of cylinder rows are provided. The second cylinder block 12 and the second cylinder head 14 define a cylinder bank in which a plurality of cylinder rows are provided. That is, in the power unit 10, the cylinder banks in which the plurality of cylinder rows are provided are aligned along the right-left direction of the outboard motor main body 101.

As shown in FIG. 4, the first fuel injector 15 and the second fuel injector 16 are attached to the first cylinder head 13 and the second cylinder head 14, respectively. The first fuel injector 15 and the second fuel injector 16 inject hydrogen inside the first cylinder head 13 and the second cylinder head 14, respectively. Each of the first fuel injector 15 and the second fuel injector 16 includes an injector to inject fuel and a delivery pipe to supply fuel to the injector.

The power unit 10 is driven by hydrogen as fuel. Specifically, hydrogen is supplied to each of the first fuel injector 15 and the second fuel injector 16 from the plurality of hydrogen tanks 112 (see FIG. 1) in the hull 110 (see FIG. 1). The first fuel injector 15 and the second fuel injector 16 inject hydrogen as fuel into combustion chambers inside the first cylinder head 13 and the second cylinder head 14, respectively. In the combustion chambers inside the first cylinder head 13 and the second cylinder head 14, a mixture of hydrogen as fuel and air supplied from an intake system IS (described below) is combusted to cause pistons (not shown) in the cylinders of the first cylinder block 11 (see FIG. 3) and the second cylinder block 12 (see FIG. 3) to reciprocate. The reciprocating motion of the pistons is transmitted to the crankshaft.

As shown in FIG. 3, the power unit 10 includes the intake system IS and an exhaust system ES. The intake system IS supplies air taken in from outside the outboard motor 100 (see FIG. 2) to the first cylinder head 13 and the second cylinder head 14. The exhaust system ES exhausts (discharges) exhaust gas generated by burning the air-fuel mixture in the first cylinder head 13 and the second cylinder head 14 to the outside of the outboard motor 100.

The exhaust system ES includes a first exhaust manifold 17, a second exhaust manifold 18, and an exhaust pipe 19. The first exhaust manifold 17 is connected to the first cylinder head 13, and exhaust gas from the first cylinder head 13 passes through the first exhaust manifold 17. The first exhaust manifold 17 is located rearward of the first cylinder head 13 in the forward-rearward direction (see FIG. 2) of the outboard motor main body 101. The second exhaust manifold 18 is connected to the second cylinder head 14, and exhaust gas from the second cylinder head 14 passes through the second exhaust manifold 18. The second exhaust manifold 18 is located rearward of the second cylinder head 14 in the forward-rearward direction of the outboard motor main body 101. Exhaust gas that has passed through the first exhaust manifold 17 and exhaust gas that has passed through the second exhaust manifold 18 pass through the exhaust pipe 19. That is, the exhaust pipe 19 is provided downstream of the first exhaust manifold 17 and the second exhaust manifold 18 in the exhaust system ES. The exhaust pipe 19 is located below the first exhaust manifold 17 and the second exhaust manifold 18 in the upward-downward direction of the outboard motor main body 101. The exhaust pipe 19 is connected to ends (lower ends in the upward-downward direction of the outboard motor main body 101) of the first exhaust manifold 17 and the second exhaust manifold 18.

The power unit 10 includes a first cylinder head cover 13a and a second cylinder head cover 14a. The first cylinder head cover 13a is attached to the rear side of the first cylinder head 13 in the forward-rearward direction of the outboard motor main body 101 (see FIG. 2). The second cylinder head cover 14a is attached to the rear side of the second cylinder head 14 in the forward-rearward direction of the outboard motor main body 101.

As shown in FIG. 4, the outboard motor 100 includes a first pipe 41, a second pipe 42, a flexible pipe 43, a first joint 44, a second joint 45, and a third pipe 46. The first pipe 41, the second pipe 42, the third pipe 46, and the flexible pipe 43 have a strength that allows high-pressure hydrogen to pass therethrough. The first joint 44 and the second joint 45 are airtight against high-pressure hydrogen. The first pipe 41, the second pipe 42, the third pipe 46, and the flexible pipe 43 are made of metal (stainless steel, for example).

The first pipe 41 is a pipe through which high-pressure hydrogen is supplied to the first fuel injector 15. Specifically, the first pipe 41 extends along the upward-downward direction of the outboard motor main body 101 (see FIG. 2). An end 41a of the first pipe 41 on a first side (the upper side in the upward-downward direction of the outboard motor main body 101) is connected to the first fuel injector 15.

The second pipe 42 is a pipe through which high-pressure hydrogen is supplied to the second fuel injector 16. Specifically, the second pipe 42 extends along the upward-downward direction of the outboard motor main body 101 (see FIG. 2). An end 42a of the second pipe 42 on the first side (the upper side in the upward-downward direction of the outboard motor main body 101) is connected to the second fuel injector 16. The second pipe 42 is located to the right of the first pipe 41 in the right-left direction of the outboard motor main body 101.

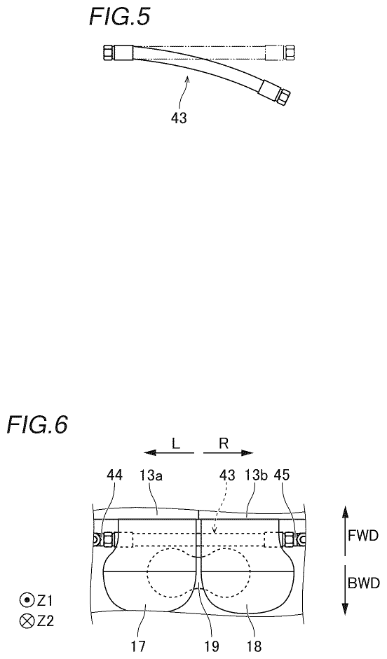

The flexible pipe 43 connects the first pipe 41 to the second pipe 42 so as to allow high-pressure hydrogen to flow therethrough to both the first pipe 41 and the second pipe 42. Specifically, the flexible pipe 43 extends along the right-left direction of the outboard motor main body 101 (see FIG. 2). An end 43a of the flexible pipe 43 on a third side (the left side in the right-left direction of the outboard motor main body 101) is connected to an end 41b of the first pipe 41 on a second side (the lower side in the upward-downward direction of the outboard motor main body 101) via the first joint 44. That is, the first joint 44 connects the first pipe 41 to the end 43a of the flexible pipe 43 on the third side. An end 43b of the flexible pipe 43 on a fourth side (the right side in the right-left direction of the outboard motor main body 101) is connected to an end 42b of the second pipe 42 on the second side (the lower side in the upward-downward direction of the outboard motor main body 101) via the second joint 45. That is, the second joint 45 connects the second pipe 42 to the end 43b of the flexible pipe 43 on the fourth side. As shown in FIG. 5, the flexible pipe 43 is a bendable pipe that has a corrugated or braided structure. The flexible pipe 43 acts as a rigid structural body when high-pressure hydrogen is supplied thereto. The end 43a of the flexible pipe 43 on the third side is an example of a “first end of the flexible pipe”, and the end 43b of the flexible pipe 43 on the fourth side is an example of a “second end of the flexible pipe”.

As shown in FIG. 4, the first joint 44 has a T-shape as viewed in the forward-rearward direction of the outboard motor main body 101 so as to connect the end 41b on the second side (the lower side in the upward-downward direction of the outboard motor main body 101) of the first pipe 41 extending along the upward-downward direction of the outboard motor main body 101 (see FIG. 2), the end 43a on the third side (the left side in the right-left direction of the outboard motor main body 101) of the flexible pipe 43 extending along the right-left direction of the outboard motor main body 101, and a first end 46a of the third pipe 46 to each other. In other words, the first joint 44 connects the first pipe 41 to the flexible pipe 43 such that a central axis extending in the longitudinal direction (the upward-downward direction of the outboard motor main body 101) of the first pipe 41 and a central axis extending in the longitudinal direction (the right-left direction of the outboard motor main body 101) of the flexible pipe 43 intersect with each other.

The second joint 45 has an L-shape as viewed in the forward-rearward direction of the outboard motor main body 101 so as to connect the end 43b on the second side (the lower side in the upward-downward direction of the outboard motor main body 101) of the second pipe 42 extending along the upward-downward direction of the outboard motor main body 101 (see FIG. 2) to the end 43b on the fourth side (the right side in the right-left direction of the outboard motor main body 101) of the flexible pipe 43 extending along the right-left direction of the outboard motor main body 101. In other words, the second joint 45 connects the second pipe 42 to the flexible pipe 43 such that a central axis extending in the longitudinal direction (the upward-downward direction of the outboard motor main body 101) of the second pipe 42 and a central axis extending in the longitudinal direction (the right-left direction of the outboard motor main body 101) of the flexible pipe 43 intersect with each other.

The first end 46a of the third pipe 46 is connected to the first pipe 41 and the flexible pipe 43 via the first joint 44. As shown in FIG. 3, a second end 46b of the third pipe 46 is connected to a hull-outboard motor pipe (not shown) that connects the third pipe 46 to a pipe (not shown) on the hull 110 (see FIG. 1) side that is connected to the plurality of hydrogen tanks 112 (see FIG. 1). In other words, the third pipe 46 is a pipe through which high-pressure hydrogen is supplied from the hydrogen tanks 112 of the hull 110 to the first pipe 41 and the flexible pipe 43.

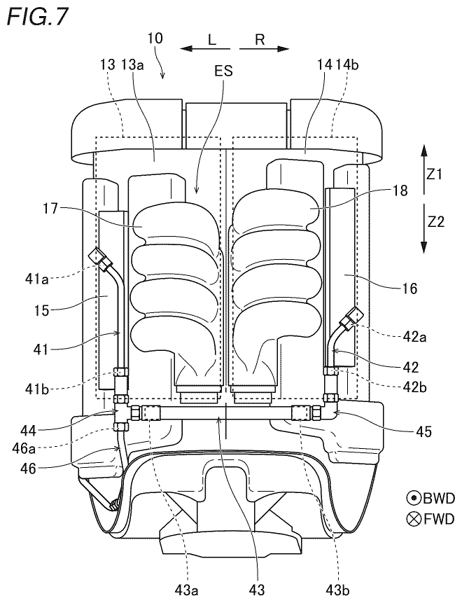

As shown in FIG. 6, at least a portion of the flexible pipe 43 overlaps the first exhaust manifold 17 and the second exhaust manifold 18 as viewed in the upward-downward direction of the outboard motor main body 101 (see FIG. 2). Specifically, as shown in FIG. 7, the flexible pipe 43 is located below the first exhaust manifold 17 and the second exhaust manifold 18 in the upward-downward direction of the outboard motor main body 101. As shown in FIG. 6, a portion of the flexible pipe 43 other than the vicinity of the end 43a on the third side (the left side in the right-left direction of the outboard motor main body 101) and the vicinity of the end 43b on the fourth side (the right side in the right-left direction of the outboard motor main body 101) overlaps the first exhaust manifold 17 and the second exhaust manifold 18 as viewed in the upward-downward direction of the outboard motor main body 101.

As shown in FIG. 4, at least a portion of the flexible pipe 43 overlaps the exhaust pipe 19 as viewed in the forward-rearward direction of the outboard motor main body 101 (see FIG. 2). Specifically, a central portion of the flexible pipe 43 in the right-left direction of the outboard motor main body 101 overlaps the exhaust pipe 19 as viewed in the forward-rearward direction of the outboard motor main body 101. As shown in FIG. 6, at least a portion (the central portion in the right-left direction of the outboard motor main body 101) of the flexible pipe 43 is located forward of at least a portion (a portion on the first exhaust manifold 17 and second exhaust manifold 18 side) of the exhaust pipe 19 in the forward-rearward direction of the outboard motor main body 101. That is, the flexible pipe 43 is located between the exhaust pipe 19 and both the first cylinder head cover 13a and the second cylinder head cover 14a in the forward-rearward direction of the outboard motor main body 101.

As shown in FIG. 2, the outboard motor 100 includes a hydrogen detection sensor 51 inside the cowling 31 to detect hydrogen. The hydrogen detection sensor 51 is located at an upper end 31a of the cowling 31 and in the vicinity of a ventilation opening 31b on a surface of the cowling 31 that connects the inside of the cowling 31 to the outside of the cowling 31. In other words, the ventilation opening 31b is located at the upper end 31a of the cowling 31.

According to the various example embodiments of the present invention described above, the following advantageous effects are achieved.

According to an example embodiment of the present invention, the outboard motor 100 includes the first pipe 41 made of metal to allow high-pressure hydrogen to be supplied therethrough to the first fuel injector 15, the second pipe 42 made of metal to allow high-pressure hydrogen to be supplied therethrough to the second fuel injector 16, and the flexible pipe 43 made of bendable metal to connect the first pipe 41 to the second pipe 42 so as to allow high-pressure hydrogen to flow therethrough to both the first pipe 41 and the second pipe 42. Accordingly, even when connection positions of the flexible pipe 43 to the first pipe 41 and the second pipe 42 are misaligned due to assembly errors of the first pipe 41 and the second pipe 42 to the outboard motor 100 when the flexible pipe 43 is connected to the first pipe 41 and the second pipe 42, the misalignments of the connection positions of the flexible pipe 43 to the first pipe 41 and the second pipe 42 are absorbed by the bendable flexible pipe 43. Consequently, even when the connection positions between the high-pressure metal pipes to allow high-pressure hydrogen to be supplied therethrough to the first fuel injector 15 and the second fuel injector 16 of the power unit 10 are misaligned, the misalignments of the connection positions are absorbed, and the connections are easily made. When a pressure from high-pressure hydrogen is not acting on the flexible pipe 43, the flexible pipe 43 is bendable, and thus the flexible pipe 43 is easily connected to the first pipe 41 and the second pipe 42. When a pressure from high-pressure hydrogen is acting on the flexible pipe 43, the rigidity of the flexible pipe 43 is increased, and thus the strength against vibrations generated in the flexible pipe 43 due to vibrations of the power unit 10, external disturbances (such as waves) acting on the outboard motor main body 101, etc. is increased.

According to an example embodiment of the present invention, the outboard motor 100 includes the first joint 44 airtight against high-pressure hydrogen to connect the first pipe 41 to the end 43a of the flexible pipe 43 on the third side, and the second joint 45 airtight against high-pressure hydrogen to connect the second pipe 42 to the end 43b of the flexible pipe 43 on the fourth side. Accordingly, the first joint 44 and the second joint 45 enable the high-pressure flexible pipe 43 to be connected to the first high-pressure pipe 41 and the second high-pressure pipe 42 while airtightness against high-pressure hydrogen is achieved.

According to an example embodiment of the present invention, the flexible pipe 43 extends along the right-left direction of the outboard motor main body 101. Accordingly, the first pipe 41 and the second pipe 42, which are provided on one side and the other side in the right-left direction of the outboard motor main body 101, respectively, are connected to each other at the shortest distance.

According to an example embodiment of the present invention, the power unit 10 includes the first exhaust manifold 17 rearward of the first cylinder head 13 in the forward-rearward direction of the outboard motor main body 101 and connected to the first cylinder head 13 to allow exhaust gas to pass therethrough from the first cylinder head 13, and the second exhaust manifold 18 rearward of the second cylinder head 14 in the forward-rearward direction of the outboard motor main body 101 and connected to the second cylinder head 14 to allow exhaust gas to pass therethrough from the second cylinder head 14. Furthermore, at least a portion of the flexible pipe 43 overlaps the first exhaust manifold 17 and the second exhaust manifold 18 as viewed in the upward-downward direction of the outboard motor main body 101. Accordingly, in the forward-rearward direction perpendicular to the upward-downward direction of the outboard motor main body 101, the power unit 10 and the flexible pipe 43 are compactly configured.

According to an example embodiment of the present invention, the power unit 10 includes the exhaust pipe 19 below the first exhaust manifold 17 and the second exhaust manifold 18 in the upward-downward direction of the outboard motor main body 101 and connected to the first exhaust manifold 17 and the second exhaust manifold 18 to allow the exhaust gas that has passed through the first exhaust manifold 17 and the exhaust gas that has passed through the second exhaust manifold 18 to pass therethrough. Furthermore, at least a portion of the flexible pipe 43 overlaps the exhaust pipe 19 as viewed in the forward-rearward direction of the outboard motor main body 101. Accordingly, in the upward-downward direction perpendicular to the forward-rearward direction of the outboard motor main body 101, the power unit 10 and the flexible pipe 43 are compactly configured.

According to an example embodiment of the present invention, at least a portion of the flexible pipe 43 is forward of at least a portion of the exhaust pipe 19 in the forward-rearward direction of the outboard motor main body 101. Accordingly, at least a portion of the flexible pipe 43 easily overlaps the exhaust pipe 19 as viewed in the forward-rearward direction of the outboard motor main body 101.

According to an example embodiment of the present invention, the power unit 10 includes the first cylinder head cover 13a and the second cylinder head cover 14a attached to the rear sides of the first cylinder head 13 and the second cylinder head 14, respectively, in the forward-rearward direction of the outboard motor main body 101. Furthermore, at least a portion of the flexible pipe 43 is between the exhaust pipe 19 and both the first cylinder head cover 13a and the second cylinder head cover 14a in the forward-rearward direction of the outboard motor main body 101. Accordingly, a space between the exhaust pipe 19 and both the first cylinder head cover 13a and the second cylinder head cover 14a in the forward-rearward direction of the outboard motor main body 101 is effectively used to locate the flexible pipe 43.

According to an example embodiment of the present invention, the outboard motor 100 includes the third pipe 46 made of metal and connected to the first pipe 41 and the flexible pipe 43 via the first joint 44 to allow high-pressure hydrogen to be supplied therethrough to the first pipe 41 and the flexible pipe 43. Accordingly, the third pipe allows high-pressure hydrogen to be easily supplied to the first pipe 41 and the flexible pipe 43.

According to an example embodiment of the present invention, the outboard motor main body 101 includes the cowling 31 to house the power unit 10. Furthermore, the outboard motor 100 includes the hydrogen detection sensor 51 inside the cowling 31 to detect hydrogen. Accordingly, when hydrogen leaks from the pipes, the hydrogen detection sensor 51 detects the hydrogen, and thus leakage of the hydrogen from the pipes is dealt with promptly.

According to an example embodiment of the present invention, the hydrogen detection sensor 51 is at the upper end 31a of the cowling 31 and in the vicinity of the ventilation opening 31b on the surface of the cowling 31 that connects the inside of the cowling 31 to the outside of the cowling 31. Accordingly, the hydrogen detection sensor 51 is at a location inside the cowling 31 at which hydrogen is relatively easy to detect, and thus when hydrogen leaks from the pipes, the hydrogen detection sensor 51 easily detects the hydrogen.

The example embodiments of the present invention described above are illustrative in all points and not restrictive. The extent of the present invention is not defined by the above description of the example embodiments but by the scope of the claims, and all modifications within the meaning and range equivalent to the scope of the claims are further included.

For example, while the flexible pipe 43 preferably extends along the right-left direction of the outboard motor main body 101 in example embodiments described above, the present invention is not restricted to this. In an example embodiment of the present invention, the flexible pipe may alternatively extend along a direction other than the right-left direction of the outboard motor main body.

While at least a portion of the flexible pipe 43 preferably overlaps the first exhaust manifold 17 and the second exhaust manifold 18 as viewed in the upward-downward direction of the outboard motor main body 101 in example embodiments described above, the present invention is not restricted to this. In an example embodiment of the present invention, the flexible pipe may not overlap the first exhaust manifold and the second exhaust manifold as viewed in the upward-downward direction of the outboard motor main body.

While at least a portion of the flexible pipe 43 preferably overlaps the exhaust pipe 19 as viewed in the forward-rearward direction of the outboard motor main body 101 in example embodiments described above, the present invention is not restricted to this. In an example embodiment of the present invention, the flexible pipe may not overlap the exhaust pipe as viewed in the forward-rearward direction of the outboard motor main body.

While at least a portion of the flexible pipe 43 is preferably located forward of at least a portion of the exhaust pipe 19 in the forward-rearward direction of the outboard motor main body 101 in example embodiments described above, the present invention is not restricted to this. In an example embodiment of the present invention, at least a portion of the flexible pipe may not be located forward of at least a portion of the exhaust pipe in the forward-rearward direction of the outboard motor main body.

While at least a portion of the flexible pipe 43 is preferably located between the exhaust pipe 19 and both the first cylinder head cover 13a and the second cylinder head cover 14a in the forward-rearward direction of the outboard motor main body 101 in example embodiments described above, the present invention is not restricted to this. In an example embodiment of the present invention, the flexible pipe may not be located between the exhaust pipe and both the first cylinder head cover and the second cylinder head cover in the forward-rearward direction of the outboard motor main body.

While the outboard motor 100 preferably includes the hydrogen detection sensor 51 inside the cowling 31 to detect hydrogen in example embodiments described above, the present invention is not restricted to this. In an example embodiment of the present invention, the outboard motor may not include the hydrogen detection sensor inside the cowling to detect hydrogen.

While the hydrogen detection sensor 51 is preferably located at the upper end 31a of the cowling 31 and in the vicinity of the ventilation opening 31b on the surface of the cowling 31 that connects the inside of the cowling 31 to the outside of the cowling 31 in example embodiments described above, the present invention is not restricted to this. In an example embodiment of the present invention, the hydrogen detection sensor may alternatively be located in the cowling at a location other than the upper end, or may alternatively be located other than the vicinity of the ventilation opening on the surface of the cowling that connects the inside of the cowling to the outside of the cowling.

While the ventilation opening 31b is preferably located at the upper end 31a of the cowling 31 in example embodiments described above, the present invention is not restricted to this. In an example embodiment of the present invention, the ventilation opening may alternatively be located at a location other than the upper end of the cowling.

While the cylinder banks in which the plurality of cylinder rows are provided in the power unit 10 are preferably aligned along the right-left direction of the outboard motor main body 101 in example embodiments described above, the present invention is not restricted to this. In an example embodiment of the present invention, at least one cylinder bank in which a plurality of cylinder rows are provided is only required to be provided. In such a case, the outboard motor preferably includes the power unit including at least one cylinder bank in which a plurality of cylinder rows are provided, and a fuel injector to inject hydrogen into combustion chambers inside the cylinder rows of the cylinder bank and to be driven by hydrogen as fuel, a fuel pipe made of metal to allow high-pressure hydrogen to be supplied therethrough to the fuel injector, a flexible pipe made of bendable metal, having a corrugated or braided structure, connected to the fuel pipe so as to allow the high-pressure hydrogen to flow therethrough to the fuel pipe, and a joint to connect the fuel pipe to the flexible pipe such that a central axis extending in the longitudinal direction of the fuel pipe and a central axis extending in the longitudinal direction of the flexible pipe intersect with each other, and the flexible pipe preferably acts as a rigid structural body when high-pressure hydrogen is supplied therethrough. Accordingly, when the flexible pipe is connected to the fuel pipe, the bendable flexible pipe absorbs the misalignment of the connection position of the flexible pipe to the fuel pipe even when the connection position of the flexible pipe to the fuel pipe is misaligned due to an assembly error of the fuel pipe to the outboard motor. That is, the flexible pipe made of metal is easily connected to the fuel pipe made of metal. Consequently, similarly to the example embodiments described above, even when the connection position between the high-pressure metal pipes to allow the high-pressure hydrogen to be supplied therethrough to the fuel injector of the power unit to be driven by hydrogen as fuel is misaligned, the misalignment of the connection position is absorbed, and the connection is easily made. Furthermore, similarly to the example embodiments described above, when a pressure from the high-pressure hydrogen is not acting on the flexible pipe, the flexible pipe is bendable, and thus the flexible pipe is easily connected to the fuel pipe. In addition, the fuel injector includes the joint to connect the fuel pipe to the flexible pipe such that the central axis extending in the longitudinal direction of the fuel pipe and the central axis extending in the longitudinal direction of the flexible pipe intersect with each other, and the flexible pipe acts as a rigid structural body when high-pressure hydrogen is supplied therethrough. Thus, the strength against vibrations generated in the flexible pipe due to vibrations of the power unit, external disturbances (such as waves) acting on an outboard motor main body, etc. is increased.

While the power unit 10 preferably includes an engine in example embodiments described above, the present invention is not restricted to this. In an example embodiment of the present invention, the power unit may alternatively be a hybrid power unit including a motor and an engine, or may be a range extender.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An outboard motor comprising:
an outboard motor main body;
a power unit configured to be driven by hydrogen as a fuel and including a first cylinder head and a second cylinder head aligned along a right-left direction of the outboard motor main body, and a first fuel injector and a second fuel injector attached to the first cylinder head and the second cylinder head to inject the hydrogen into combustion chambers inside the first cylinder head and the second cylinder head, respectively;
a propeller to be driven via a drive shaft and a propeller shaft both below the power unit;
a first pipe made of metal to allow high-pressure hydrogen to be supplied therethrough to the first fuel injector;
a second pipe made of metal to allow the high-pressure hydrogen to be supplied therethrough to the second fuel injector; and
a flexible pipe made of bendable metal, having a corrugated or braided structure, to connect the first pipe to the second pipe so as to allow the high-pressure hydrogen to flow therethrough to both the first pipe and the second pipe.

2. The outboard motor according to claim 1, further comprising:
a first joint airtight against the high-pressure hydrogen to connect the first pipe to a first end of the flexible pipe; and
a second joint airtight against the high-pressure hydrogen to connect the second pipe to a second end of the flexible pipe.

3. The outboard motor according to claim 1, wherein the flexible pipe extends along the right-left direction of the outboard motor main body.

4. The outboard motor according to claim 1, wherein
the power unit includes:
a first exhaust manifold rearward of the first cylinder head in a forward-rearward direction of the outboard motor main body and connected to the first cylinder head to allow exhaust gas to pass therethrough from the first cylinder head; and
a second exhaust manifold rearward of the second cylinder head in the forward-rearward direction of the outboard motor main body and connected to the second cylinder head to allow exhaust gas to pass therethrough from the second cylinder head; and
at least a portion of the flexible pipe overlaps the first exhaust manifold and the second exhaust manifold as viewed in an upward-downward direction of the outboard motor main body.

5. The outboard motor according to claim 4, wherein
the power unit includes an exhaust pipe below the first exhaust manifold and the second exhaust manifold in the upward-downward direction of the outboard motor main body and connected to the first exhaust manifold and the second exhaust manifold to allow the exhaust gas that has passed through the first exhaust manifold and the exhaust gas that has passed through the second exhaust manifold to pass therethrough; and
at least a portion of the flexible pipe overlaps the exhaust pipe as viewed in the forward-rearward direction of the outboard motor main body.

6. The outboard motor according to claim 5, wherein at least a portion of the flexible pipe is forward of at least a portion of the exhaust pipe in the forward-rearward direction of the outboard motor main body.

7. The outboard motor according to claim 6, wherein
the power unit includes a first cylinder head cover and a second cylinder head cover attached to rear sides of the first cylinder head and the second cylinder head, respectively, in the forward-rearward direction of the outboard motor main body; and
at least a portion of the flexible pipe is between the exhaust pipe and both the first cylinder head cover and the second cylinder head cover in the forward-rearward direction of the outboard motor main body.

8. The outboard motor according to claim 2, further comprising:
a third pipe made of metal and connected to the first pipe and the flexible pipe via the first joint to allow the high-pressure hydrogen to be supplied therethrough to the first pipe and the flexible pipe.

9. The outboard motor according to claim 1, wherein
the outboard motor main body includes a cowling to house the power unit; and
the outboard motor further comprises a hydrogen detection sensor inside the cowling to detect the hydrogen.

10. The outboard motor according to claim 9, wherein the hydrogen detection sensor is at least either at an upper end of the cowling or in a vicinity of a ventilation opening on a surface of the cowling that connects an inside of the cowling to an outside of the cowling.

11. A marine vessel comprising:
a hull including a hydrogen tank filled with hydrogen; and
an outboard motor attached to the hull; wherein
the outboard motor includes:
an outboard motor main body;
a power unit configured to be driven by the hydrogen as fuel and including a first cylinder head and a second cylinder head aligned along a right-left direction of the outboard motor main body, and a first fuel injector and a second fuel injector attached to the first cylinder head and the second cylinder head to inject the hydrogen into combustion chambers inside the first cylinder head and the second cylinder head,
respectively;
a propeller to be driven via a drive shaft and a propeller shaft both below the power unit;
a first pipe made of metal to allow high-pressure hydrogen to be supplied therethrough to the first fuel injector;
a second pipe made of metal to allow the high-pressure hydrogen to be supplied therethrough to the second fuel injector; and
a flexible pipe made of bendable metal, having a corrugated or braided structure, to connect the first pipe to the second pipe so as to allow the high-pressure hydrogen to flow therethrough to both the first pipe and the second pipe.

12. The marine vessel according to claim 11, further comprising:
a first joint airtight against the high-pressure hydrogen to connect the first pipe to a first end of the flexible pipe; and
a second joint airtight against the high-pressure hydrogen to connect the second pipe to a second end of the flexible pipe.

13. The marine vessel according to claim 11, wherein the flexible pipe extends along the right-left direction of the outboard motor main body.

14. The marine vessel according to claim 11, wherein
the power unit includes:
a first exhaust manifold rearward of the first cylinder head in a forward-rearward direction of the outboard motor main body and connected to the first cylinder head to allow exhaust gas to pass therethrough from the first cylinder head; and
a second exhaust manifold rearward of the second cylinder head in the forward-rearward direction of the outboard motor main body and connected to the second cylinder head to allow exhaust gas to pass therethrough from the second cylinder head; and
at least a portion of the flexible pipe overlaps the first exhaust manifold and the second exhaust manifold as viewed in an upward-downward direction of the outboard motor main body.

15. The marine vessel according to claim 14, wherein
the power unit includes an exhaust pipe below the first exhaust manifold and the second exhaust manifold in the upward-downward direction of the outboard motor main body and connected to the first exhaust manifold and the second exhaust manifold to allow the exhaust gas that has passed through the first exhaust manifold and the exhaust gas that has passed through the second exhaust manifold to pass therethrough; and
at least a portion of the flexible pipe overlaps the exhaust pipe as viewed in the forward-rearward direction of the outboard motor main body.

16. The marine vessel according to claim 15, wherein at least a portion of the flexible pipe is forward of at least a portion of the exhaust pipe in the forward-rearward direction of the outboard motor main body.

17. The marine vessel according to claim 16, wherein
the power unit includes a first cylinder head cover and a second cylinder head cover attached to rear sides of the first cylinder head and the second cylinder head, respectively, in the forward-rearward direction of the outboard motor main body; and
at least a portion of the flexible pipe is between the exhaust pipe and both the first cylinder head cover and the second cylinder head cover in the forward-rearward direction of the outboard motor main body.

18. The marine vessel according to claim 12, further comprising:
a third pipe made of metal and connected to the first pipe and the flexible pipe via the first joint to allow the high-pressure hydrogen supplied from the hydrogen tank of the hull to be supplied therethrough to the first pipe and the flexible pipe.

19. The marine vessel according to claim 11, wherein
the outboard motor main body includes a cowling to house the power unit; and
the marine vessel further comprises a hydrogen detection sensor inside the cowling to detect the hydrogen.

20. An outboard motor comprising:
a power unit configured to be driven by hydrogen as fuel and including at least one cylinder bank including a plurality of cylinder rows, and a fuel injector to inject hydrogen into combustion chambers inside the plurality of cylinder rows of the cylinder bank;
a propeller to be driven via a drive shaft and a propeller shaft both below the power unit;
a fuel pipe made of metal to allow high-pressure hydrogen to be supplied therethrough to the fuel injector;
a flexible pipe made of bendable metal, having a corrugated or braided structure, and connected to the fuel pipe so as to allow the high-pressure hydrogen to flow therethrough to the fuel pipe; and
a joint to connect the fuel pipe to the flexible pipe such that a central axis extending in a longitudinal direction of the fuel pipe and a central axis extending in a longitudinal direction of the flexible pipe intersect with each other;
wherein
the flexible pipe is a rigid structural body when the high-pressure hydrogen is supplied therethrough.
